(19) United States
(12) Patent Application Publication
(10) Pub. No.: US 2025/0110017 A1
(43) Pub. Date: Apr. 3, 2025

(54) INSPECTION METHOD AND INSPECTION DEVICE OF OPTICAL FIBER RIBBON

(71) Applicant: SUMITOMO ELECTRIC INDUSTRIES, LTD., Osaka (JP)

(72) Inventors: Hiroki ISHIKAWA, Osaka (JP); Tatsuya KUROKI, Osaka (JP); Yoshiki SONOYAMA, Osaka (JP); Fumiaki SATO, Osaka (JP); Kenta TSUCHIYA, Osaka (JP); Reo AMANO, Osaka (JP); Kenji KAWAI, Osaka (JP); Kounan SHIN, Osaka (JP); Satoshi YOSHIKAWA, Osaka (JP); Itaru SAKABE, Osaka (JP)

(21) Appl. No.: 18/899,160

(22) Filed: Sep. 27, 2024

(30) Foreign Application Priority Data
Sep. 29, 2023 (JP) 2023-169693

(51) Int. Cl. G01M 11/00; G06T 7/00; G06T 7/70; G06T 7/90

(52) U.S. Cl. CPC G01M 11/31; G06T 7/0004; G06T 7/70; G06T 7/90; G06T 2207/10024; G06T 2207/30108

(57) ABSTRACT

An inspection method of an optical fiber ribbon where a plurality of colored optical fibers are intermittently connected in a longitudinal direction through a connecting resin in a state where the optical fibers are arranged in parallel, the inspection method includes a step of irradiating a surface of the optical fiber ribbon with light from a light source while causing the optical fiber ribbon to travel in the longitudinal direction, and causing an imaging device to acquire a two-dimensional color image based on scattered light that is emitted from the light source and scattered from the surface of the optical fiber ribbon; and a step of specifying colors and positions of the optical fibers based on the color image.

### CROSS-REFERENCE TO RELATED APPLICATION

This application claims priority from Japanese Patent Application No. 2023-169693, filed on Sep. 29, 2023, the entire subject matter of which is incorporated herein by reference.

### TECHNICAL FIELD

The present disclosure relates to an inspection method and an inspection device of an optical fiber ribbon.

### BACKGROUND

JP2001-43759A discloses an inspection method and an inspection device of a flat cable formed of optical fibers (signal wires) of dark colors (for example, orange, red, blue, green, and black) and optical fibers of bright colors (for example, white and yellow). In this inspection device, a line censor is disposed perpendicular to a surface of the flat cable, and an illuminating device is disposed such that light is incident oblique to the surface of the flat cable. By binarizing the brightness of an image acquired by the line censor in terms of a bright portion and a dark portion and calculating the number of bright portions or dark portions, whether arrangement of optical fibers is good or bad is inspected.

JP2017-125780A discloses an inspection method of an intermittently connected optical fiber ribbon in which one-dimensional images in a width direction of the optical fiber ribbon are acquired by a camera and a two-dimensional image is generated by accumulating the one-dimensional images, and a connecting portion is inspected from the two-dimensional image. In this inspection method, the optical fiber ribbon is disposed between the camera and an illuminating device, illumination light (leakage light) is detected through the optical fiber ribbon, and a light intensity distribution along the width direction is measured. In addition, the optical fiber ribbon is supported by a guide roller including a step portion to separate the non-connecting portion.

JP2012-042354A discloses an inspection method of an intermittently connected optical fiber ribbon in which the length or the like of a non-connecting portion between connecting portions is measured. In this inspection method, the optical fiber ribbon is supported by a guide roller including a step portion to separate the non-connecting portion, an image of the optical fiber ribbon is acquired by a camera, and an edge interval, the number of edges, and the like are measured from the image.

JP2002-304922A discloses an inspection method of a flat cable in which a transmission image of the flat cable is acquired by a CCD camera to inspect a conduction and insulation coating state along a longitudinal direction of the flat cable.

### SUMMARY

In a case where the above-described inspection method based on the light and darkness of the image is applied to inspection of an optical fiber ribbon, for example, when optical fibers that are colored with colors having similar brightness values are disposed adjacent to each other, it is difficult to detect replacement or reversal of the optical fibers. In addition, in an inspection method using leakage light, whether a gap is present between optical fibers can be detected, but replacement or reversal of the optical fibers cannot be detected.

The present disclosure provides an inspection method and an inspection device of an optical fiber ribbon in which arrangement of optical fibers can be accurately specified.

An embodiment of the present disclosure provides an inspection method of an optical fiber ribbon where a plurality of colored optical fibers are intermittently connected in a longitudinal direction through a connecting resin in a state where the optical fibers are arranged in parallel, the inspection method including:
a step of irradiating a surface of the optical fiber ribbon with light from a light source while causing the optical fiber ribbon to travel in the longitudinal direction, and causing an imaging device to acquire a two-dimensional color image based on scattered light that is emitted from the light source and scattered from the surface of the optical fiber ribbon; and
a step of specifying colors and positions of the optical fibers based on the color image.

According to the present disclosure, it is possible to provide an inspection method and an inspection device of an optical fiber ribbon in which arrangement of optical fibers can be accurately specified.

### BRIEF DESCRIPTION OF DRAWINGS

FIG. 1 is a schematic diagram illustrating a configuration of an inspection device of an optical fiber ribbon according to an embodiment.

FIG. 2 is a plan view illustrating a configuration of the optical fiber ribbon.

FIG. 3 is a cross-sectional view illustrating a configuration of a cross-section taken along line III-III in FIG. 2 when seen from an arrow direction.

FIG. 4 is a cross-sectional view illustrating a configuration of a cross-section taken along line IV-IV in FIG. 2 when seen from an arrow direction.

FIG. 5 is a schematic diagram illustrating a configuration of a manufacturing device of an optical fiber ribbon into which the inspection device is incorporated.

FIG. 6 is a diagram illustrating an imaging range (field of view) of an imaging device for a surface of the optical fiber ribbon.

FIG. 7 is a flowchart illustrating an inspection method of the optical fiber ribbon.

FIG. 8 is a diagram illustrating an image of the optical fiber ribbon.

FIG. 9 is a diagram illustrating a reference image of the optical fiber ribbon.

FIG. 10 is a diagram illustrating another example of the image of the optical fiber ribbon.

FIG. 11 is a diagram illustrating an optical fiber ribbon where an arrangement abnormality of optical fibers occurs.

### DESCRIPTION OF EMBODIMENTS

### Description of Embodiment of Present Disclosure

First, aspects of the present disclosure will be described.

(1) An inspection method of an optical fiber ribbon according to the present disclosure is
an inspection method of an optical fiber ribbon where a plurality of colored optical fibers are intermittently connected in a longitudinal direction through a connecting resin in a state where the optical fibers are arranged in parallel, the inspection method including:
a step of irradiating a surface of the optical fiber ribbon with light from a light source while causing the optical fiber ribbon to travel in the longitudinal direction, and causing an imaging device to acquire a two-dimensional color image based on scattered light that is emitted from the light source and scattered from the surface of the optical fiber ribbon; and
a step of specifying colors and positions of the optical fibers based on the color image.

In the above-described method, the color and the position of each of the optical fibers configuring the optical fiber ribbon can be specified from the two-dimensional color image based on the scattered light. Therefore, arrangement of the optical fibers can be accurately specified.

(2) The inspection method of the optical fiber ribbon according to (1),
may further include a step of determining whether arrangement of the optical fibers is normal based on the specified colors and the specified positions of the optical fibers.

With the above-described method, an arrangement abnormality such as replacement or reversal of one or plural units of optical fibers can be detected.

(3) In the inspection method of the optical fiber ribbon according to (1) or (2),
an imaging period T [ms] of the imaging device may be set such that the imaging period T, a length L [mm] of an imaging range in the longitudinal direction of the imaging device, and a traveling speed V [m/min] of the optical fiber ribbon satisfy a relational expression of T<L/(V/60).

In the above-described method, an i-th (i represents a natural number other than zero) acquired image and an i+1-th acquired image partially overlap each other in the longitudinal direction of the optical fiber ribbon. Therefore, the optical fiber ribbon can be closely inspected over the entire length.

(4) In the inspection method of the optical fiber ribbon according to (3),
when an overlapping width a [mm] in the longitudinal direction of imaging ranges imaged before and after the imaging period T is set to a constant, the imaging period T may be changed depending on the traveling speed V of the optical fiber ribbon such that a relational expression of T=(L−α)/(V/60) is satisfied.

In the above-described method, the overlapping width of the images acquired before and after the imaging period T is fixed. Therefore, even when the traveling speed V of the optical fiber ribbon changes, the color and the position of the optical fibers are easily specified.

(5) In the inspection method of the optical fiber ribbon according to any one of (1) to (4),
the imaging device may be disposed such that a first angle between the surface of the optical fiber ribbon and incidence light emitted from the light source and incident on the surface of the optical fiber ribbon and a second angle between the surface of the optical fiber ribbon and scattered light scattered from the surface of the optical fiber ribbon and incident on the imaging device are different from each other.

In the above-described method, incidence of specularly reflected light on the imaging device can be suppressed. Therefore, the occurrence of blown out highlights on the surface of the optical fiber ribbon in the image can be prevented.

(6) In the inspection method of the optical fiber ribbon according to (5),
the first angle may be 25° or more and 35° or less, and
the second angle may be 85° or more and 95° or less.

When the first angle is less than 25°, the intensity of scattered light from the optical fiber ribbon decreases, and it is difficult to specify the colors and the positions of the optical fibers. On the other hand, when the first angle is more than 35°, specularly reflected light enters the imaging device due to a fine shape of the surface of the optical fiber ribbon, and a part of the image may be blown out. In the above-described method, the first angle is 25° or more and 35° or less. Therefore, the colors and the positions of the optical fibers are easily specified. In addition, the second angle is 85° or more and 95° or less and is substantially 90°.Therefore, scattered light from a direction substantially perpendicular to the surface of the optical fiber ribbon can be incident on the imaging device, and scattered light can be received most efficiently.

(7) In the inspection method of the optical fiber ribbon according to any one of (1) to (6),
the step of specifying colors and positions of the optical fibers based on the color image may include:
a step of specifying a region where each of the optical fibers is imaged in the color image; and
a step of specifying a color of each of the specified regions.

In the above-described method, the region corresponding to each of the optical fibers and the color of the region are specified. Therefore, a process of noise removal such as removal of blown out highlights is unnecessary. As a result, the inspection of the optical fiber ribbon can be rapidly executed, and the inspection can be executed on the optical fiber ribbon traveling at a high speed.

(8) In the inspection method of the optical fiber ribbon according to any one of (1) to (7),
the optical fiber ribbon may include a plurality of sub-ribbons each of which includes two optical fibers and a coating resin that continuously covers a periphery of the two optical fibers in the longitudinal direction, and
in a state where the sub-ribbons are arranged in parallel, the sub-ribbons adjacent to each other may be intermittently connected to each other in the longitudinal direction through the connecting resin.

In the above-described method, even in a two-core intermittent optical fiber ribbon, the arrangement of the optical fibers can be accurately specified. In the two-core intermittent optical fiber ribbon, the plurality of sub-ribbons are intermittently connected. Therefore, the flexibility of the optical fiber ribbon can be improved, and the optical fiber ribbon can be accommodated in an optical cable with high density. In addition, the optical fibers are integrated in each of the sub-ribbons. Therefore, when the plurality of optical fibers configuring the optical fiber ribbon are collectively spliced, easy handling can be implemented.

(9) A manufacturing device of an optical fiber ribbon according to the present disclosure is
an inspection device of an optical fiber ribbon where a plurality of colored optical fibers are intermittently connected in a longitudinal direction through a connecting resin in a state where the optical fibers are arranged in parallel, the inspection method including:
a light source configured to irradiate a surface of the optical fiber ribbon with light, the optical fiber ribbon traveling in the longitudinal direction;
an imaging device configured to acquire a two-dimensional color image based on scattered light that is emitted from the light source and scattered from the surface of the optical fiber ribbon; and
a control device configured to specify colors and positions of the optical fibers based on the color image.

In the above-described configuration, the color and the position of each of the optical fibers configuring the optical fiber ribbon can be specified from the two-dimensional color image based on the scattered light. Therefore, arrangement of the optical fibers can be accurately grasped.

(10) In the inspection device of the optical fiber ribbon according to (9),
the control device may determine whether arrangement of the optical fibers is normal based on the specified colors and the specified positions of the optical fibers.

With the above-described configuration, an arrangement abnormality such as replacement or reversal of one or plural units of optical fibers can be detected.

(11) In the inspection device of the optical fiber ribbon according to (9) or (10),
the imaging device may be disposed such that a first angle between the surface of the optical fiber ribbon and incidence light emitted from the light source and incident on the surface of the optical fiber ribbon and a second angle between the surface of the optical fiber ribbon and scattered light scattered from the surface of the optical fiber ribbon and incident on the imaging device are different from each other.

In the above-described configuration, incidence of specularly reflected light on the imaging device can be suppressed. Therefore, the occurrence of blown out highlights on the surface of the optical fiber ribbon in the image can be prevented.

(12) In the inspection device of the optical fiber ribbon according to (11),
the first angle may be 25° or more and 35° or less, and
the second angle may be 85° or more and 95° or less.

When the first angle is less than 25°, the intensity of scattered light from the optical fiber ribbon decreases, and it is difficult to specify the colors and the positions of the optical fibers. On the other hand, when the first angle is more than 35°, specularly reflected light enters the imaging device due to a fine shape of the surface of the optical fiber ribbon, and a part of the image may be blown out. In the above-described configuration, the first angle is 25° or more and 35° or less. Therefore, the colors and the positions of the optical fibers are easily specified. In addition, the second angle is 85° or more and 95° or less and is substantially 90°. Therefore, scattered light from a direction substantially perpendicular to the surface of the optical fiber ribbon can be incident on the imaging device, and scattered light can be received most efficiently.

(13) In the inspection device of the optical fiber ribbon according to any one of (9) to (12),
the control device
may specify a region where each of the optical fibers is imaged in the color image; and
may specify a color of each of the specified regions.

In the above-described configuration, the region corresponding to each of the optical fibers and the color of the region are specified. Therefore, a process of noise removal such as removal of blown out highlights is unnecessary. As a result, the inspection of the optical fiber ribbon can be rapidly executed, and the inspection can be executed on the optical fiber ribbon traveling at a high speed.

[Details of Embodiment of Present Disclosure] A specific example of the inspection method and the inspection device of the optical fiber ribbon according to the present disclosure will be described with reference to the drawings. The present invention is not limited to these examples and is intended to include any modifications within the scope and meaning equivalent to the terms of the claims.

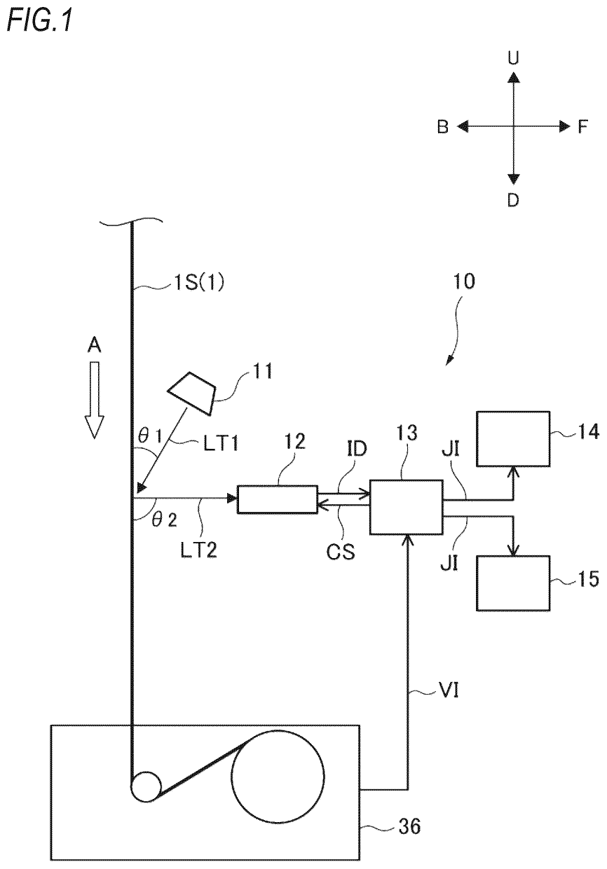

In the drawings, an arrow U represents an upward direction of a structure illustrated in the drawing. An arrow D represents a downward direction of the structure illustrated in the drawing. An arrow F represents a forward direction of the structure illustrated in the drawing. An arrow B represents a backward direction of the structure illustrated in the drawing. An arrow R represents a right direction of the structure illustrated in the drawing. An arrow L represents a left direction of the structure illustrated in the drawing. These directions are relative directions set for an inspection device 10 of an optical fiber ribbon illustrated in FIG. 1.

### Inspection Device of Optical Fiber Ribbon

FIG. 1 is a schematic diagram illustrating a configuration of the inspection device 10 of an optical fiber ribbon 1 according to the present embodiment. The inspection device 10 is a device used for inspecting the optical fiber ribbon 1 where a plurality of optical fibers are intermittently connected in a longitudinal direction through a connecting resin in a state where the optical fibers are arranged in parallel.

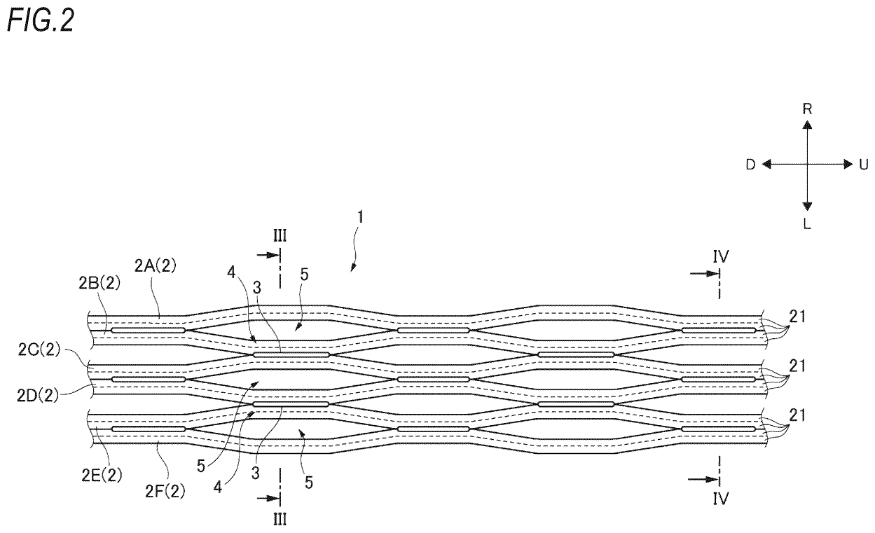

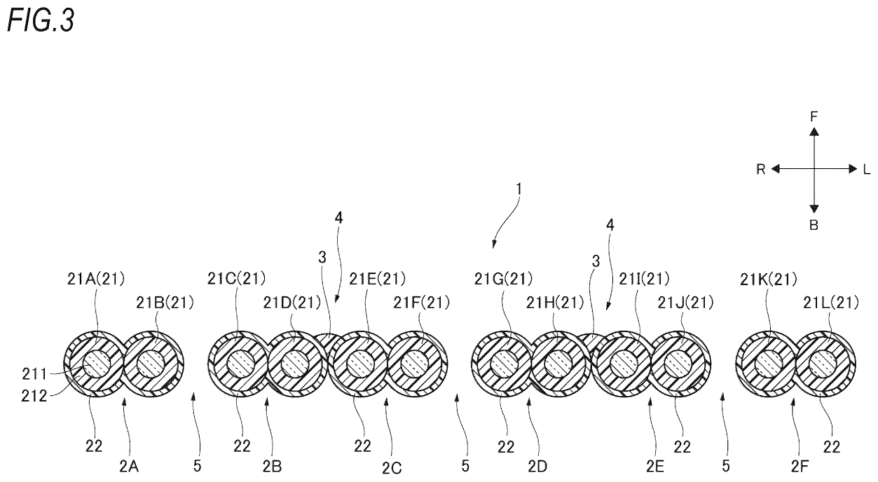

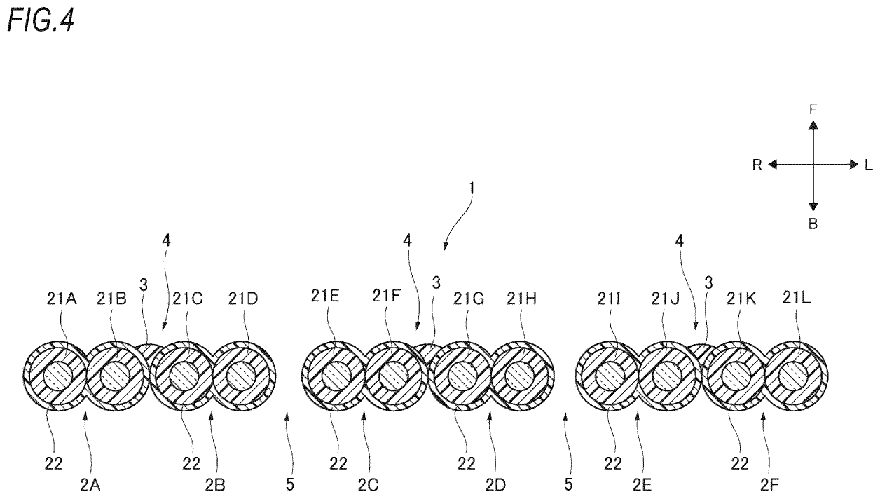

FIG. 2 illustrates an example of the optical fiber ribbon 1. FIG. 2 illustrates the optical fiber ribbon 1 in a state where non-connecting portions 5 are widened in an arrangement direction of optical fibers 21. FIGS. 3 and 4 illustrate a cross-sectional shape of the optical fiber ribbon 1 of FIG. 2.

As illustrated in FIG. 2, the optical fiber ribbon 1 includes the plurality of optical fibers 21. As illustrated in FIG. 3, each of the optical fibers 21 includes a glass fiber 211 and a coating layer 212. The glass fiber 211 is formed of, for example, a core and a cladding. The coating layer 212 covers the periphery of the glass fiber 211. The coating layer 212 may be formed of a plurality of coating layers including a colored layer that is colored with a predetermined color as the outermost layer. For example, the colored layers of the optical fibers 21 may be colored with different colors.

The two optical fibers 21 adjacent to each other are integrated by a coating resin 22 in a state where the two optical fibers are continuously in contact with each other in the longitudinal direction, and thus a sub-ribbon 2 is formed. The coating resin 22 covers the periphery of the two optical fibers 21 adjacent to each other in the longitudinal direction. The coating resin 22 is formed of, for example, a resin material such as an acrylic ultraviolet curable resin or an epoxy ultraviolet curable resin. The coating resin 22 is, for example, a transparent resin.

As illustrated in FIG. 2, the plurality of sub-ribbons 2 are intermittently connected in the longitudinal direction through a connecting resin 3 in a state where the sub-ribbons are arranged in parallel. As a result, in the optical fiber ribbon 1, a connecting portions 4 where the sub-ribbons 2 adjacent to each other are connected through the connecting resin 3 and the non-connecting portions 5 where the sub-ribbons 2 adjacent to each other are not connected are intermittently provided in the longitudinal direction. The connecting resin 3 is formed of, for example, a resin material such as an acrylic ultraviolet curable resin or an epoxy ultraviolet curable resin. The connecting resin 3 is, for example, a transparent resin. The connecting resin 3 may be formed of the same resin material as the coating resin 22.

In the present example, as illustrated in FIGS. 3 and 4, the optical fiber ribbon 1 includes 12 optical fibers 21A to 21L, and the two optical fibers 21 adjacent to each other (21A and 21B, 21C and 21D, 21E and 21F, 21G and 21H, 21I and 21J, 21K and 21L) form the sub-ribbons 2 (2A, 2B, 2C, 2D, 2E, 2F).

The inspection of the optical fiber ribbon 1 by the inspection device 10 is executed, for example, in a step of manufacturing the optical fiber ribbon 1.

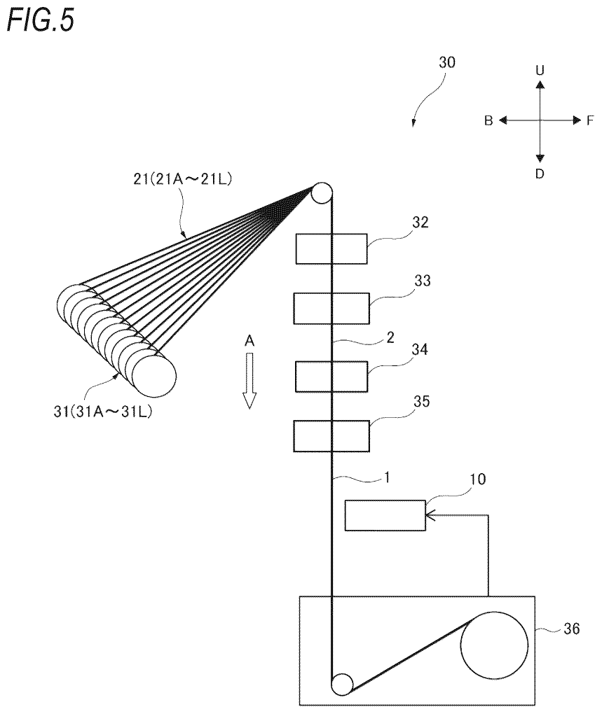

FIG. 5 illustrates a configuration of a manufacturing device 30 of the optical fiber ribbon 1 into which the inspection device 10 is incorporated. The inspection device 10 is configured to inspect the optical fiber ribbon 1 formed by the manufacturing device 30.

Specifically, the manufacturing device 30 includes a supply bobbin 31, a first application device 32, a first curing device 33, a second application device 34, a second curing device 35, and a winding-up machine 36.

The optical fibers 21A to 21L wound around supply bobbins 31A to 31L are drawn out and transported to the first application device 32. In the first application device 32, the coating resin 22 is applied to the periphery of the two optical fibers 21 adjacent to each other among the plurality of optical fibers 21A to 21L. Next, the coating resin 22 applied to the periphery of the optical fibers 21 is cured, for example, by ultraviolet irradiation in the first curing device 33. As a result, the plurality of sub-ribbons 2 where the two optical fibers 21 are integrated by the coating resin 22 are formed.

Next, the plurality of sub-ribbons 2 are transported to the second application device 34 in a state where the sub-ribbons are arranged in parallel. In the second application device 34, the connecting resin 3 is applied between the sub-ribbons 2 adjacent to each other. Next, the connecting resin 3 applied between the sub-ribbons 2 adjacent to each other is cured, for example, by ultraviolet irradiation in the second curing device 35. As a result, the optical fiber ribbon 1 where the plurality of sub-ribbons 2 are intermittently connected in the longitudinal direction through the connecting resin 3 is formed. The optical fiber ribbon 1 is wound up around the winding-up machine 36. The operation of each of the devices is controlled by an intermittent application control device (not illustrated).

In the present example, the optical fibers 21A to 21L drawn out from the supply bobbins 31A to 31L travel in the downward direction (direction indicated by the arrow A in the drawing), and form the optical fiber ribbon 1 in a state where the optical fibers 21A to 21L are arranged in a direction (horizontal direction in the drawing) orthogonal to the paper plane of FIG. 5. In the present example, the optical fiber ribbon 1 travels such that the longitudinal direction thereof is along the vertical direction.

The inspection device 10 is disposed between the second curing device 35 and the winding-up machine 36, and inspects whether the arrangement of the plurality of optical fibers 21 configuring the optical fiber ribbon 1 traveling in the downward direction from the second curing device 35 is normal.

Specifically, as illustrated in FIG. 1, the inspection device 10 includes a light source 11, an imaging device 12, and a camera control device 13. The camera control device 13 corresponds to the control device according to the present disclosure. The light source 11 is configured to irradiate a surface 1S of the optical fiber ribbon 1 traveling in the longitudinal direction with light. The surface 1S of the optical fiber ribbon 1 with which the light from the light source 11 is irradiated is a surface along an arrangement direction of the plurality of optical fibers 21, and is a surface of the optical fiber ribbon 1 where the connecting resin 3 is provided or a surface opposite to the surface where the connecting resin 3 is provided. The light source 11 emits, for example, white light. The surface 1S includes a certain amount of unevenness, but it is assumed that the surface 1S is a flat surface where the unevenness is leveled off.

In a cross-section along the longitudinal direction and perpendicular to the surface 1S of the optical fiber ribbon 1, the light source 11 is disposed to emit light in a direction having a first angle θ1 with respect to the surface 1S of the optical fiber ribbon 1. In other words, the first angle θ1 is an angle between the surface 1S of the optical fiber ribbon 1 and incidence light LT1 that is emitted from the light source 11 and is incident on the surface 1S of the optical fiber ribbon 1. The first angle θ1 is set to be, for example, 25° or more and 35° or less.

The imaging device 12 is configured to acquire a two-dimensional color image based on light that is emitted from the light source 11 and is scattered from the surface 1S of the optical fiber ribbon 1. The imaging device 12 is, for example, a CMOS camera.

In the cross-section along the longitudinal direction and perpendicular to the surface of the optical fiber ribbon 1, the imaging device 12 is disposed such that light scattered from the surface of the optical fiber ribbon 1 in a direction having a second angle θ2 with respect to the surface 1S of the optical fiber ribbon 1 is incident. In other words, the second angle θ2 is an angle between the surface 1S of the optical fiber ribbon 1 and scattered light LT2 that is incident on the imaging device 12. The second angle θ2 is set to be, for example, an angle different from the first angle θ1. The second angle θ2 is set to be, for example, 90°.

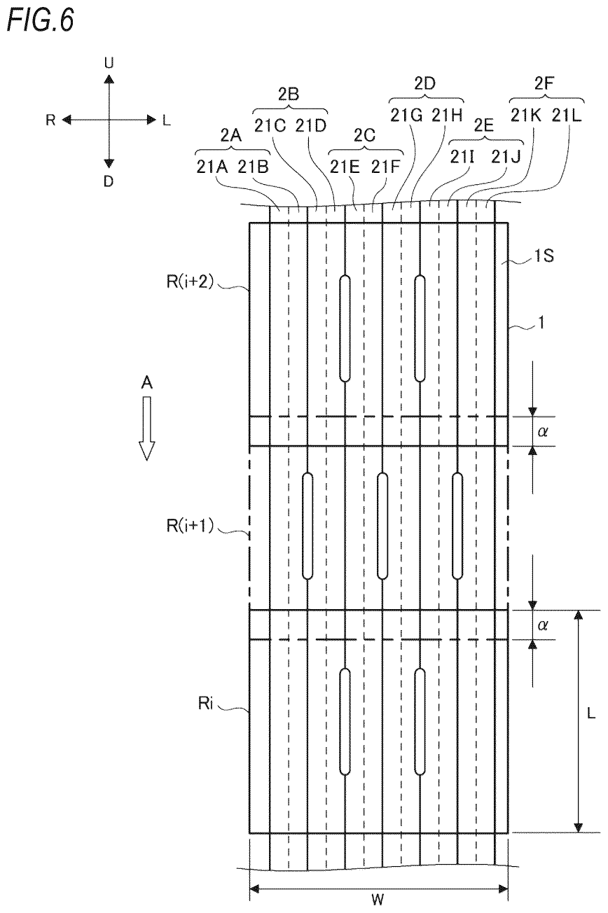

The imaging device 12 periodically acquires an image from the optical fiber ribbon 1 traveling in the longitudinal direction. FIG. 6 illustrates an imaging range (field of view) of the imaging device 12 for the surface 1S of the optical fiber ribbon 1. In FIG. 6, Ri represents an i-th imaging range, R(i+1) represents an i+1-th imaging range, and R(i+2) represents an i+2-th imaging range. i represents a natural number other than zero. Each of the imaging ranges is defined by the length L [mm] in the longitudinal direction of the optical fiber ribbon 1 and a length W [mm] in a width direction of the optical fiber ribbon 1.

An imaging period of the imaging device 12 is set such that, for example, imaging ranges (for example, Ri and R(i+1) or R(i+1) and R(i+2)) imaged before and after the imaging period partially overlap each other. Specifically, for example, assuming that the imaging period is represented by T [ms], the length of the imaging range in the longitudinal direction of the optical fiber ribbon 1 is represented by L [mm], and a traveling speed of the optical fiber ribbon 1 is represented by V [m/min], the imaging period Tis set such that a relational expression of T<L/(V/60) is satisfied.

Alternatively, assuming that an overlapping width in the longitudinal direction of the imaging ranges imaged before and after the imaging period T is represented by a [mm], when the overlapping width a is set to a constant, the imaging period T may be set to be changed depending on the traveling speed V of the optical fiber ribbon 1 such that a relational expression of T=(L−α)/(V/60) is satisfied. The overlapping width a is set such that, for example, a relational expression of 0.1<α/L<0.5 is satisfied.

Referring back to FIG. 1, the camera control device 13 is, for example, a general-purpose computer including: a general-purpose memory; and a general-purpose microprocessor that operates in cooperation with the general-purpose memory.

The camera control device 13 is configured to control the operation of the imaging device 12. For example, the camera control device 13 determines the imaging period T of the imaging device 12 based on the overlapping width a of the imaging ranges, the length L of the imaging range, and the traveling speed V of the optical fiber ribbon 1. The camera control device 13 outputs a control signal CS for executing imaging in the determined imaging period T to the imaging device 12. The imaging device 12 sets or changes the imaging period T based on the control signal CS. The camera control device 13 is connected to, for example, the winding-up machine 36, and acquires information VI regarding a winding-up speed of the optical fiber ribbon 1 as information regarding the traveling speed V of the optical fiber ribbon 1 from the winding-up machine 36.

In addition, the camera control device 13 acquires a data ID of a color image where the optical fiber ribbon 1 is imaged from the imaging device 12. The camera control device 13 specifies the color and the position of each of the optical fibers 21 in the optical fiber ribbon 1 based on the acquired color image. The camera control device 13 determines whether arrangement of the plurality of optical fibers 21 configuring the optical fiber ribbon 1 is normal based on the specified color and the specified position of each of the optical fibers 21. For example, when the plurality of optical fibers 21 are arranged in a predetermined order, the camera control device 13 determines that the arrangement of the optical fibers 21 is normal. On the other hand, when the plurality of optical fibers 21 are not arranged in the predetermined order, the camera control device 13 determines that the arrangement of the optical fibers 21 is abnormal.

The camera control device 13 outputs the determination result of the arrangement of the optical fibers 21. For example, the inspection device 10 includes a display device 14 and a storage device 15. The camera control device 13 outputs the determination result JI of the arrangement of the optical fibers 21 to the display device 14, and causes the display device 14 to display the determination result JI of the arrangement of the optical fibers 21. In addition, the camera control device 13 outputs the determination result JI of the arrangement of the optical fibers 21 to the storage device 15, and stores the determination result JI of the arrangement of the optical fibers 21 in the storage device 15.

### Inspection Method of Optical Fiber Ribbon 1

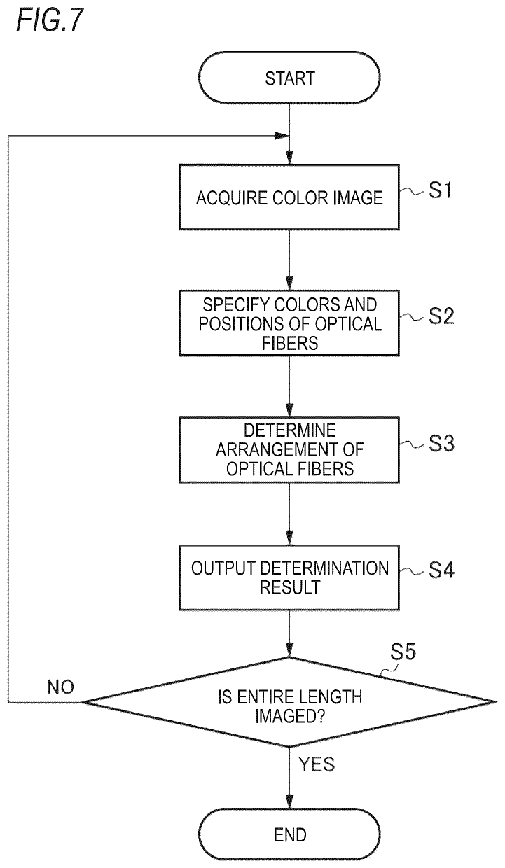

Hereinafter, an inspection method of the optical fiber ribbon 1 using the inspection device 10 will be described using FIGS. 7 to 11. FIG. 7 is a flowchart illustrating the inspection method of the optical fiber ribbon 1.

First, the surface 1S of the optical fiber ribbon 1 is irradiated with light from the light source 11 while causing the optical fiber ribbon 1 to travel in the longitudinal direction, and the imaging device 12 acquires a two-dimensional color image based on scattered light that is emitted from the light source 11 and scattered from the surface 1S of the optical fiber ribbon 1 (STEP 1).

Next, the camera control device 13 specifies the colors and the positions of the optical fibers 21 configuring the optical fiber ribbon 1 based on the color image of the surface 1S of the optical fiber ribbon 1 acquired from the imaging device 12 (STEP 2).

Specifically, the camera control device 13 specifies a region where each of the optical fibers 21 is imaged in the color image, and specifies a color of each of the specified regions.

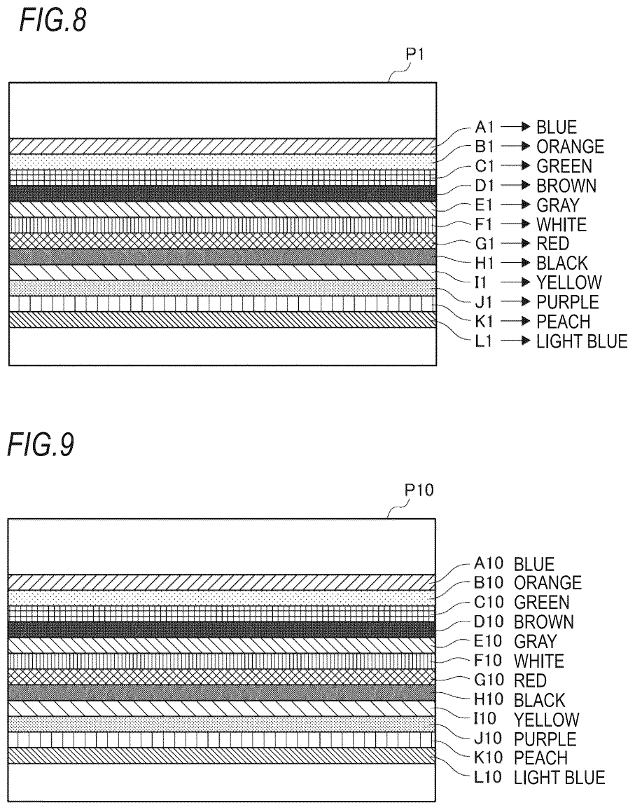

FIG. 8 illustrates a color image P1 of the optical fiber ribbon 1 acquired by the imaging device 12. In FIG. 8, a difference in color in the image P1 is represented by a difference in hatching pattern. The camera control device 13 specifies the region where each of the optical fibers 21 is imaged based on the color of each of the pixels configuring the image P1.

The color image acquired by the imaging device 12 is, for example, a color image represented in the HSV color space where colors are represented by Hue, Saturation, and Value. Based on the values of the HSV color space represented by each of the pixels configuring the image, the camera control device 13 specifies, for example, a region surrounded by a pixel group having the same values of Hue, Saturation, and Value as a region where one optical fiber is imaged.

In the image P1 illustrated in FIG. 8, a region A1, a region B1, a region C1, a region D1, a region E1, a region F1, a region G1, a region H1, a region I1, a region J1, a region K1, and a region L1 are specified as the regions where the optical fibers 21 are imaged, respectively.

Next, the camera control device 13 quantifies the color in each of the specified regions, and compares the numerical value of the quantified color of each of the regions and the numerical value of a color of each of optical fibers in a reference image to each other to specify the color of each of the regions.

FIG. 9 is a diagram illustrating a reference image P10. The reference image P10 is a two-dimensional color image obtained by imaging in advance the optical fiber ribbon 1 where the arrangement of the optical fibers 21 is normal. In the present example, in the reference image P10, the optical fiber ribbon 1 where twelve optical fibers 21 of blue, orange, green, brown, gray, white, red, black, yellow, purple, peach, and light blue are arranged in order from above to below is imaged. The colors of regions A10 to L10 where the optical fibers 21 are imaged in the reference image P10 are quantified in advance. Information regarding the reference image P10, the colors of the regions A10 to L10 where the optical fibers 21 are imaged, and the numerical values and the positions thereof is stored in the memory of the camera control device 13 or the storage device 15.

The camera control device 13 quantifies the color of the region A in the image P1 illustrated in FIG. 8 based on, for example, the values of Hue, Saturation, and Value in the HSV color space. The camera control device 13 compares the numerical value of the color of the region A to the numerical values of the colors of the regions A10 to L10 in the reference image P10 of FIG. 9, and classifies the color of the region A into the color of a region having a numerical value closest to the color of the region A in the image P1 among the regions A10 to L10 in the reference image P10. For example, when the numerical value of the color of the region A1 in the image P1 illustrated in FIG. 8 is the same as the numerical value of the color of the region A10 in the reference image P10 illustrated in FIG. 9, The color of the region A1 in the image P1 illustrated in FIG. 8 is classified into “blue” that is the color of the region A10 in the reference image P10.

Likewise, the colors of the regions B1 to L1 in the image P1 illustrated in FIG. 8 are also classified based on the reference image P10. As a result, the color of the region B1 in the image P1 is classified into “orange” that is the color of the region B10 in the reference image P10, the color of the region C1 is classified into “green” that is the color of the region C10 in the reference image P10, the color of the region D1 is classified into “brown” that is the color of the region D10 in the reference image P10, the color of the region El is classified into “gray” that is the color of the region E10 in the reference image P10, the color of the region F1 is classified into “white” that is the color of the region F10 in the reference image P10, the color of the region G1 is classified into “red” that is the color of the region G10 in the reference image P10, the color of the region H1 is classified into “black” that is the color of the region H10 in the reference image P10, the color of the region I1 is classified into “yellow” that is the color of the region I10 in the reference image P10, the color of the region J1 is classified into “purple” that is the color of the region J10 in the reference image P10, the color of the region K1 is classified into “peach” that is the color of the region K10 in the reference image P10, and the color of the region L1 is classified into “light blue” that is the color of the region L10 in the reference image P10.

Next, the camera control device 13 determines whether arrangement of the plurality of optical fibers 21 configuring the optical fiber ribbon 1 is normal based on the specified color and the specified position of each of the optical fibers 21 (STEP 3 in FIG. 7). Specifically, the camera control device 13 determines the arrangement of the optical fibers 21 based on the classified color of each of the regions in the image P1 illustrated in FIG. 8, and determines whether the determined arrangement of the optical fibers 21 is the same as the arrangement of the optical fibers 21 in the reference image P10.

For example, based on the colors and the positions of the region A1 to the region L1 in the image P1 illustrated in FIG. 8, the camera control device 13 determines that twelve optical fibers 21 of blue, orange, green, brown, gray, white, red, black, yellow, purple, peach, and light blue are arranged in order from above to below in the optical fiber ribbon 1 imaged in the image P1. The camera control device 13 determines that the arrangement of the optical fibers 21 in the image P1 illustrated in FIG. 8 is the same as the arrangement of the optical fibers 21 in the reference image P10 illustrated in FIG. 9.

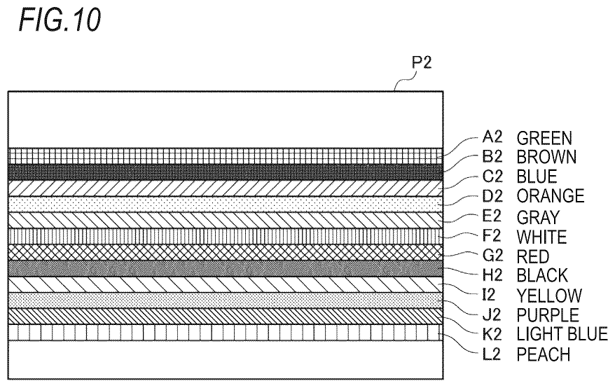

On the other hand, FIG. 10 illustrates an image P2 of the optical fiber ribbon 1 formed of the optical fibers 21 having arrangement different from that of FIG. 8. In the image P2 illustrated in FIG. 10, the optical fiber ribbon 1 where the optical fibers 21 of green, brown, blue, orange, gray, white, red, black, yellow, purple, light blue, and peach are arranged corresponding to a region A2, a region B2, a region C2, a region D2, a region E2, a region F2, a region G2, a region H2, a region I2, a region J2, a region K2, and a region L2 is imaged. Accordingly, the camera control device 13 determines that the arrangement of the optical fibers 21 configuring the optical fiber ribbon 1 imaged in the image P2 illustrated in FIG. 10 is not the same as the arrangement of the optical fibers 21 in the reference image P10 illustrated in FIG. 9.

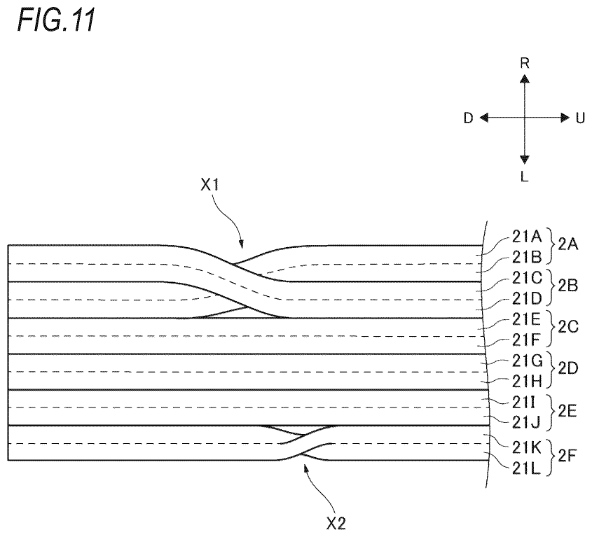

The camera control device 13 may be configured to specify a cause for the abnormality of the arrangement of the optical fibers 21. For example, the color of the region A2 in the image P2 illustrated in FIG. 10 is the same as the color of the region C10 in the reference image P10 illustrated in FIG. 9, and the color of the region B2 in the image P2 illustrated in FIG. 10 is the same as the color of the region D10 in the reference image P10 illustrated in FIG. 9. In addition, the color of the region C2 in the image P2 illustrated in FIG. 10 is the same as the color of the region A10 in the reference image P10 illustrated in FIG. 9, and the color of the region D2 in the image P2 illustrated in FIG. 10 is the same as the color of the region B10 in the reference image P10 illustrated in FIG. 9. As a result, the camera control device 13 may determine that replacement X1 of the sub-ribbons 2 occurs between the sub-ribbons 2A and 2B adjacent to each other as shown in FIG. 11.

In addition, the color of the region K2 in the image P2 illustrated in FIG. 10 is the same as the color of the region L10 in the reference image P10 illustrated in FIG. 9, and the color of the region L2 in the image P2 illustrated in FIG. 10 is the same as the color of the region K10 in the reference image P10 illustrated in FIG. 9. As a result, the camera control device 13 may determine that reversal X2 of the optical fibers 21 occurs between the optical fibers 21K and 21L adjacent to each other as illustrated in FIG. 11.

Next, the camera control device 13 outputs the determination result of the arrangement of the optical fibers 21 to the display device 14 and the storage device 15 (STEP 4 in FIG. 7). The determination result of the arrangement of the optical fibers 21 is displayed by the display device 14 and is recorded by the storage device 15. The determination result of the arrangement of the optical fibers 21 includes, for example, not only the image of the optical fiber ribbon 1 but also information such as the position where the arrangement abnormality of the optical fibers 21 occurs and the cause for the arrangement abnormality.

The camera control device 13 repeats the processes of STEP 1 to STEP 4 until the entire length of the optical fiber ribbon 1 is imaged (NO in STEP 5). On the other hand, when the entire length of the optical fiber ribbon 1 is imaged (YES in STEP 5), the camera control device 13 ends the process.

In the inspection device 10 and the manufacturing method of the optical fiber ribbon 1 according to the present embodiment, the colors and the positions of the optical fibers 21 are specified based on the color images P1 and P2 formed by scattered light. Therefore, the arrangement of the optical fibers 21 can be accurately specified.

In addition, in the present embodiment, when the overlapping width a [mm] of imaging ranges imaged before and after the imaging period Tis set to a constant, the imaging period T is changed depending on the traveling speed V of the optical fiber ribbon 1 such that a relational expression of T=(L−α)/(V/60) is satisfied. As a result, the overlapping width of the images acquired before and after the imaging period T is fixed. Therefore, even when the traveling speed V of the optical fiber ribbon changes, the color and the position of the connecting resin are easily specified.

The overlapping width a is set such that, for example, a relational expression of 0.1<α/L<0.5 is satisfied. When α/L is 0.1 or less, there may be a deviation between the traveling speed of the optical fiber ribbon 1 used when the imaging period Tis acquired during an increase or a decrease in the traveling speed of the optical fiber ribbon 1 and the actual traveling speed of the optical fiber ribbon 1. At this time, there may be an interval where imaging is not executed. On the other hand, when α/L is 0.5 or more, the i-th imaging range Ri and the i+2-th imaging range R(i+2) overlap each other such that an increase in the traveling speed of the optical fiber ribbon 1 is unnecessarily limited.

Although the present invention has been described in detail with reference to specific embodiments, it will be apparent to those skilled in the art that various changes and modifications can be made without departing from the spirit and scope of the invention. In addition, the numbers, positions, shapes, and the like of the components described above are not limited to those of the embodiments and can be changed to numbers, positions, shapes, and the like suitable for implementing the present invention.

In the above-described embodiment, the camera control device 13 determines the imaging period T of the imaging device 12. However, the imaging device 12 may be configured to determine the imaging period T. In this case, the imaging device 12 may be configured to acquire information regarding the traveling speed of the optical fiber ribbon 1 from the camera control device 13 or the winding-up machine 36.

In the above-described embodiment, the colored layers of the twelve optical fibers 21 configuring the optical fiber ribbon 1 are colored with different colors. However, the inspection method according to the present disclosure is also applicable to the optical fiber ribbon 1 where the colored layers of the optical fibers 21 positioned at a distance where the possibility of occurrence of replacement or reversal in the arrangement direction of the optical fibers 21 is low are colored with the same color.

In the above-described embodiment, the sub-ribbon 2 is formed by integrating two optical fibers 21. However, the sub-ribbon 2 may be formed by integrating three or more optical fibers 21.

In the above-described embodiment, the sub-ribbons 2 adjacent to each other are intermittently connected in the longitudinal direction through the connecting resin 3. However, the single-core optical fibers 21 adjacent to each other may be intermittently connected in the longitudinal direction through the connecting resin 3 without forming the sub-ribbon 2.

In the above-described embodiment, the inspection device 10 is configured to inspect the optical fiber ribbon 1 traveling along the vertical direction. However, the inspection device 10 may be configured to inspect the optical fiber ribbon 1 traveling along the horizontal direction.

In the above-described embodiment, the display device 14 and the storage device 15 may be configured to be integrated with the camera control device 13.

In the above-described embodiment, the camera control device 13 may be integrated with the intermittent application control device that controls the operation of the manufacturing device 30 of the optical fiber ribbon 1.

In the above-described embodiment, the number of the optical fibers 21 configuring the optical fiber ribbon 1 is 12. However, the number of the optical fibers 21 is not limited.

In the above-described embodiment, the inspection by the inspection device 10 may be incorporated into the manufacturing steps of the optical fiber ribbon 1. However, the inspection by the inspection device 10 may be executed alone. Alternatively, the inspection by the inspection device 10 may be incorporated into a step of executing any treatment on the optical fiber ribbon 1, for example, a marking process step of marking the optical fiber ribbon 1.

What is claimed is:

1. An inspection method of an optical fiber ribbon where a plurality of colored optical fibers are intermittently connected in a longitudinal direction through a connecting resin in a state where the optical fibers are arranged in parallel, the inspection method comprising:
a step of irradiating a surface of the optical fiber ribbon with light from a light source while causing the optical fiber ribbon to travel in the longitudinal direction, and causing an imaging device to acquire a two-dimensional color image based on scattered light that is emitted from the light source and scattered from the surface of the optical fiber ribbon; and
a step of specifying colors and positions of the optical fibers based on the color image.

2. The inspection method of the optical fiber ribbon according to claim 1, further comprising a step of determining whether arrangement of the optical fibers is normal based on the specified colors and the specified positions of the optical fibers.

3. The inspection method of the optical fiber ribbon according to claim 1, wherein an imaging period T [ms] of the imaging device is set such that the imaging period T, a length L [mm] of an imaging range in the longitudinal direction of the imaging device, and a traveling speed V [m/min] of the optical fiber ribbon satisfy a relational expression of T<L/(V/60).

4. The inspection method of the optical fiber ribbon according to claim 3, wherein when an overlapping width a [mm] in the longitudinal direction of imaging ranges imaged before and after the imaging period T is set to a constant, the imaging period T is changed depending on the traveling speed V of the optical fiber ribbon such that a relational expression of T=(L−α)/(V/60) is satisfied.

5. The inspection method of the optical fiber ribbon according to claim 1, wherein the imaging device is disposed such that a first angle between the surface of the optical fiber ribbon and incidence light emitted from the light source and incident on the surface of the optical fiber ribbon and a second angle between the surface of the optical fiber ribbon and scattered light scattered from the surface of the optical fiber ribbon and incident on the imaging device are different from each other.

6. The inspection method of the optical fiber ribbon according to claim 5,
wherein the first angle is 25° or more and 35° or less, and
the second angle is 85° or more and 95° or less.

7. The inspection method of the optical fiber ribbon according to claim 1,
wherein the step of specifying colors and positions of the optical fibers based on the image includes:
a step of specifying a region where each of the optical fibers is imaged in the image; and
a step of specifying a color of each of the specified regions.

8. The inspection method of the optical fiber ribbon according to claim 1,
wherein the optical fiber ribbon includes a plurality of sub-ribbons each of which includes two optical fibers and a coating resin that continuously covers a periphery of the two optical fibers in the longitudinal direction, and
in a state where the sub-ribbons are arranged in parallel, the sub-ribbons adjacent to each other are intermittently connected to each other in the longitudinal direction through the connecting resin.

9. An inspection device of an optical fiber ribbon where a plurality of colored optical fibers are intermittently connected in a longitudinal direction through a connecting resin in a state where the optical fibers are arranged in parallel, the inspection method comprising:
a light source configured to irradiate a surface of the optical fiber ribbon with light, the optical fiber ribbon traveling in the longitudinal direction;
an imaging device configured to acquire a two-dimensional color image based on scattered light that is emitted from the light source and scattered from the surface of the optical fiber ribbon; and
a control device configured to specify colors and positions of the optical fibers based on the color image.

10. The inspection device of the optical fiber ribbon according to claim 9, wherein the control device determines whether arrangement of the optical fibers is normal based on the specified colors and the specified positions of the optical fibers.

11. The inspection device of the optical fiber ribbon according to claim 9, wherein the imaging device is disposed such that a first angle between the surface of the optical fiber ribbon and incidence light emitted from the light source and incident on the surface of the optical fiber ribbon and a second angle between the surface of the optical fiber ribbon and scattered light scattered from the surface of the optical fiber ribbon and incident on the imaging device are different from each other.

12. The inspection device of the optical fiber ribbon according to claim 11,
wherein the first angle is 25° or more and 35° or less, and
the second angle is 85° or more and 95° or less.

13. The inspection device of the optical fiber ribbon according to claim 9,
wherein the control device
specifies a region where each of the optical fibers is imaged in the color image, and
specifies a color of each of the specified regions.
